(19) United States
(12) Patent Application Publication
(10) Pub. No.: US 2007/0036602 A1
(43) Pub. Date: Feb. 15, 2007

(54) Apparatus and method for detecting the amount of ink ribbon used

(75) Inventor: Chong-Wan Lee, Seoul (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/502,410

(22) Filed: Aug. 11, 2006

(30) Foreign Application Priority Data
Aug. 11, 2005 (KR) 10-2005-73820

(51) Int. Cl. B41J 33/00

(52) U.S. Cl. 400/239

(57) ABSTRACT

An apparatus and method for detecting the amount of an ink ribbon used are provided. In the apparatus, an ink ribbon includes ink layers formed on a transparent sheet, initial position boundary lines indicating initial positions of the ink layers for printing a unit of printing media, and color boundary lines dividing the ink layers depending on colors of the ink layers. A use amount detection unit detects a used amount of the ink ribbon by measuring velocity of the initial position boundary line. Therefore, the amount of the ink ribbon used can be detected even when the ink ribbon is replaced without an additional device such as a memory for storing the amount of the ink ribbon used, thereby reducing the manufacturing cost. Since the used and remaining amounts of the ink ribbon can be correctly detected, users can conveniently predict the time for replacing the ink ribbon.

### CROSS-REFERENCE TO RELATED PATENT APPLICATION

This application claims the benefit under 35 U.S.C. §119(a) of Korean Patent Application No. 10-2005-0073820, filed on Aug. 11, 2005, in the Korean Intellectual Property Office, the entire disclosure of which is hereby incorporated herein by reference.

### BACKGROUND OF THE INVENTION

1. Field of the Invention

The present invention relates to an image forming apparatus such as a printer, a facsimile and a multi-function product (MFP). More particularly, the present invention relates to a thermal transfer type image forming apparatus that forms images by applying heat with a thermal head to an ink ribbon having an ink layer formed on a transparent sheet to transfer printing dye from the ink ribbon onto paper.

2. Description of the Related Art

Referring to FIG. 2, a thermal transfer type image forming apparatus employing a sublimation method or a melting method includes an ink ribbon as a transfer ink source. Generally, the ink ribbon is loaded in a cassette and then installed in the image forming apparatus. The ink ribbon includes a plurality of equivalent printing regions which are divided based on the size of a printing medium 240. Each printing region is formed with a predetermined color ink layer. The ink ribbon is contained in the ink ribbon cassette in which the ink ribbon is wound around a feeding reel 200 and a winding reel 210. A sensor 230 detects the ink layers and boundary lines that are formed on the ink ribbon. A thermal head (TPH) 220 generates heat to transfer dye from the ink ribbon to the printing medium 240 such as paper.

Referring to FIG. 1, the ink ribbon includes initial position boundary lines 100 to indicate an initial position of the ink layers for printing a unit of printing medium. Color boundary lines 110 are also included to divide the ink layers based on colors of the ink layers. The image forming apparatus carries out printing by applying heat to the ink layers formed on the ink ribbon, such as a yellow (Y) ink layer 120, a magenta (M) ink layer 130, a cyan (C) ink layer 140, and an overcoating ink layer 150 to sequentially transfer the ink layers onto a printing medium as illustrated in 160 of FIG. 1.

There are various types of ink ribbons which are based on factors such as the size of the printing medium 240 such as an A6 size and a card size, the sensitivity of dye (or pigment), and whether an overcoating region exists, among others. Users can install an appropriate ink ribbon cassette depending on the use. Therefore, the ink ribbon cassette can be replaced before the ink ribbon is used up. If the amount of the ink ribbon used is detected by counting the number of initial position boundary lines 100, the amount of the ink ribbon used cannot be counted when the ink ribbon cassette is replaced. Further, if the amount of the ink ribbon used is detected by storing the used amount of the ink ribbon in a memory provided in the ink ribbon cassette, the manufacturing cost increases.

As described above, the used amount of the ink ribbon and the remaining amount of the ink ribbon cannot be exactly detected in the image forming apparatus. Therefore, the image forming apparatus cannot be conveniently used because there is no way of knowing when the ink ribbon is to be replaced.

Accordingly, there is a need for an improved system and method for detecting the amount of an ink ribbon used in the image forming apparatus to facilitate convenient use.

### SUMMARY OF THE INVENTION

An aspect of exemplary embodiments of the present invention is to address at least the above problems and/or disadvantages and to provide at least the advantages described below. Accordingly, an aspect of exemplary embodiments of the present invention provides an apparatus and method for detecting the amount of an ink ribbon used by measuring the velocity of initial position boundary lines formed on the ink ribbon and sensing the widths of color boundary lines.

According to an aspect of an exemplary embodiment of the present invention, there is provided an apparatus for detecting the amount of an ink ribbon used. An ink ribbon includes ink layers formed on a transparent sheet, initial position boundary lines to indicate initial positions of the ink layers for printing a unit of printing media, and color boundary lines to divide the ink layers depending on colors of the ink layers. A use amount detection unit detects a used amount of the ink ribbon by measuring velocity of the initial position boundary line.

The use amount detection unit may include a velocity measurement unit, a use amount storage unit, and a use amount determination unit. The velocity measurement unit measures the velocity of the initial position boundary line. The use amount storage unit stores the used amount of the ink ribbon corresponding to the velocity of the initial position boundary line and the use amount determination unit reads the used amount of the ink ribbon corresponding to the measured result of the velocity measurement unit from the use amount storage unit.

Each of the initial position boundary lines of the ink ribbon may include a first boundary line and a second boundary line that are opaque.

The velocity measurement unit may include a boundary line sensor unit and a velocity calculation unit. The boundary line sensor unit senses the first and second boundary lines and the velocity calculation unit calculates the velocity of the initial position line in response to the sensed result from the boundary line sensor unit.

The color boundary lines of the ink ribbon may be sized differently in width at a preset interval.

The use amount detection unit may include a velocity measurement unit, a range storage unit, a range determination unit, and a use amount calculation unit. The velocity measurement unit measures the velocity of the initial position boundary line. The range storage unit stores an ink ribbon use range that corresponds to the velocity of the initial position boundary line and is ranged based on the preset interval. The range determination unit reads the ink ribbon use range corresponding to the measured result of the velocity measurement unit from the range storage unit. The use amount calculation unit calculates the used amount of the ink ribbon from the ink ribbon use range by sensing the widths of the boundary lines.

The use amount calculation unit may calculate the used amount of the ink ribbon using the following equation
ATM=NUM_{rng}*T+NUM_{wid}

where ATM denotes the amount of the ink ribbon used, NUM_{rng} denotes the arranged order of the ink ribbon use range, T denotes the number of the ink ribbon uses within one interval, and NUM_{wid} denotes the arranged order corresponding to the sensed width of the color boundary line in the interval.

Each of the initial position lines may include a first boundary line and a second boundary line that are opaque.

The velocity measurement unit may include a boundary line sensor unit and a velocity calculation unit. The boundary line sensor unit senses the first and second boundary lines and the velocity calculation unit calculates the velocity of the initial position line in response to the sensed result from the boundary line sensor unit.

The color boundary lines of the ink ribbon may be sized differently in width at a preset interval.

The use amount detection unit may further include a read value comparison unit, a range storage unit, a range determination unit, and a use amount calculation unit. The read value comparison unit determines whether two or more values are read for the used amount of the ink ribbon by the use amount determined unit. The range storage unit stores an ink ribbon use range that corresponds to the velocity of the initial position boundary line and is ranged based on the preset interval. The range determination unit reads the ink ribbon use range corresponding to the measured result of the velocity measurement unit from the range storage unit in response to the determined result of the read value comparison unit. The use amount calculation unit calculates the used amount of the ink ribbon from the ink ribbon use range by sensing the widths of the boundary lines.

According to another aspect of an exemplary embodiment of the present invention, there is provided a method for detecting the amount of an ink ribbon used in an image forming apparatus that prints initial position boundary lines indicating initial positions of the ink layers for printing a unit of printing media, and color boundary lines dividing the ink layers depending on colors of the ink layers. The printing occurs by using the ink ribbon having ink layers formed on a transparent sheet. The velocity of the initial position boundary line is measured and the amount of the ink ribbon used is detected by using the measured velocity.

Detecting the amount of the ink ribbon used may include reading the used amount of the ink ribbon corresponding to the measured velocity from a first recording medium in which the used amount of the ink ribbon corresponding to the velocity of the initial position boundary line is stored.

The initial position boundary line may include a first boundary line and a second boundary line that are opaque.

The velocity may be measured by sensing the first boundary line and the second boundary line. The velocity of the initial position boundary line may be calculated based on the sensed result.

The color boundary lines of the ink ribbon may be sized differently in width at a preset interval.

The amount of the ink ribbon used may be detected by reading an ink ribbon use range corresponding to the measured velocity of the ink ribbon from a second recording medium storing the ink ribbon use range that corresponds to the velocity of the initial position boundary line and ranged based on the preset interval. The amount of the ink ribbon used may also be detected by calculating the used amount of the ink ribbon from the read ink ribbon use range by sensing the widths of the boundary lines.

The used amount of the ink ribbon may be calculated by using the following equation
ATM=NUM_{rng}*T+NUM_{wid}

where ATM denotes the amount of the ink ribbon used, NUM_{rng} denotes the arranged order of the ink ribbon use range, T denotes the number of the ink ribbon uses within one interval, and NUM_{wid} denotes the arranged order corresponding to the sensed width of the color boundary line in the interval.

The initial position boundary line may include a first boundary line and a second boundary line that are opaque.

The velocity may be measured by sensing the first boundary line and the second boundary line and by calculating the velocity of the initial position boundary line based on the sensed result.

The color boundary lines of the ink ribbon may be sized differently in width at a preset interval.

A determination may be made as to whether two or more values are read from the first recording medium for the used amount of the ink ribbon. If two or more values are read, an ink ribbon use range corresponding to the measured velocity of the initial position boundary line may be read from a second recording medium storing the ink ribbon use range that corresponds to the velocity of the initial position boundary line and ranged based on the preset interval. The used amount of the ink ribbon may be calculated from the read ink ribbon use range by sensing the widths of the boundary lines.

According to another aspect of an exemplary embodiment of the present invention, there is provided a computer-readable recording medium having a computer-readable program for executing the method described above.

### BRIEF DESCRIPTION OF THE DRAWINGS

The above and other exemplary objects, features and advantages of certain exemplary embodiments of the present invention will be more apparent from the following detailed description taken in conjunction with the accompanying drawings, in which:

FIG. 1 illustrates a conventional ink ribbon and a printout output using the conventional ink ribbon;

FIG. 2 schematic diagram of a conventional thermal transfer printer;

FIG. 3 is a timing diagram illustrating a result detected by a sensor 720;

FIG. 4 is a block diagram illustrating an apparatus for detecting the amount of an ink ribbon used according to an exemplary embodiment of the present invention;

FIG. 5 is a flowchart illustrating a method for detecting the amount of an ink ribbon used according to an exemplary embodiment of the present invention;

FIG. 6 illustrates an ink ribbon according to an exemplary embodiment of the present invention;

FIG. 7 illustrates an ink ribbon cassette according to an exemplary embodiment of the present invention;

FIG. 8 illustrates data stored in an amount storage unit 416 in the form of a lookup table according to an exemplary embodiment of the present invention;

FIG. 9 illustrates data stored in a range storage unit 423 in the form of a lookup table according to an exemplary embodiment of the present invention;

FIG. 10 is a graph illustrating the relationship between the amount of an ink ribbon used and the movement time of the ink ribbon according to an exemplary embodiment of the present invention; and

FIGS. 11A through 11D are waveform graphs illustrating movement times of an ink ribbon measured by an oscillograph according to an exemplary embodiment of the present invention.

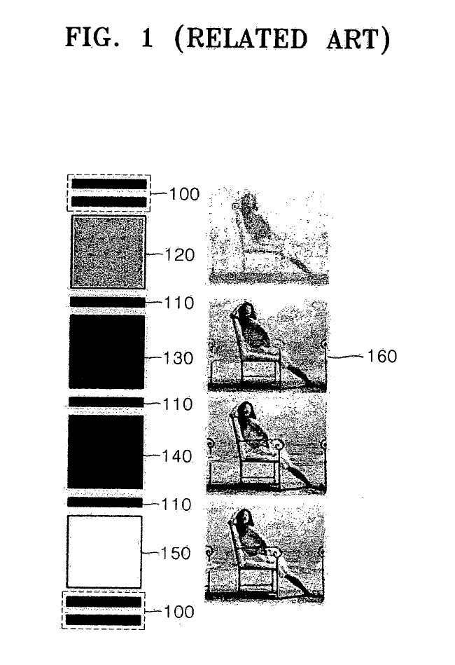

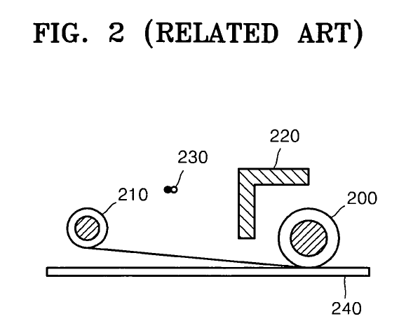

Throughout the drawings, the same drawing reference numerals will be understood to refer to the same elements, features and structures.

### DETAILED DESCRIPTION OF EXEMPLARY EMBODIMENTS

The matters defined in the description such as a detailed construction and elements, are provided to assist in a comprehensive understanding of the embodiments of the invention. Accordingly those of ordinary skill in the art will recognize that various changes and modifications of the embodiments described herein can be made without departing from the scope and spirit of the invention. Also, descriptions of well-known functions and constructions are omitted for clarity and conciseness. An apparatus and method for detecting the amount of an ink ribbon used will now be described more fully according to exemplary embodiments of the present invention with reference to the accompanying drawings.

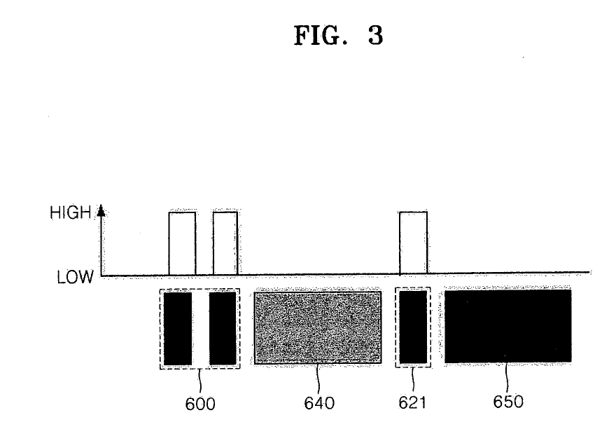

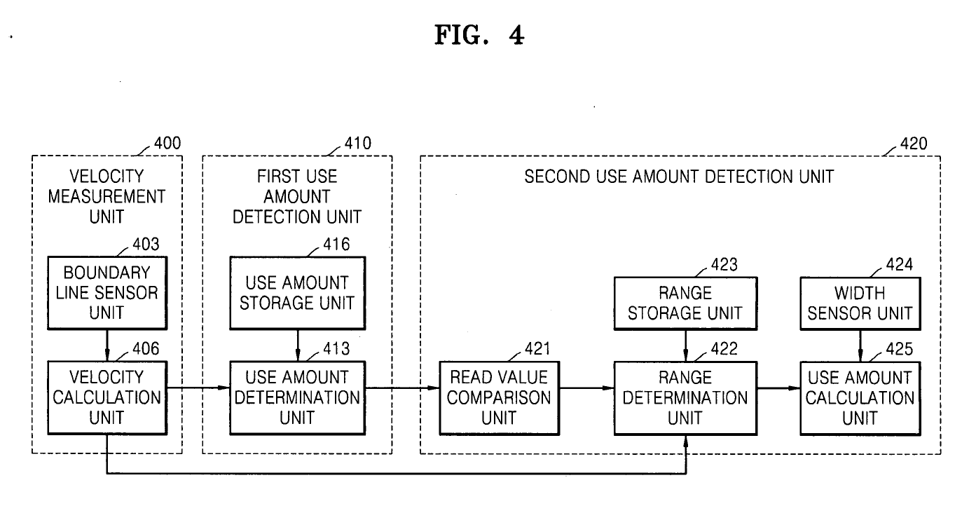

FIG. 4 is a block diagram illustrating an apparatus for detecting the amount of an ink ribbon used according to an exemplary embodiment of the present invention. The apparatus for detecting the amount of an ink ribbon used includes a velocity measurement unit 400, a first use amount detection unit 410, and a second use amount detection unit 420. Referring to FIGS. 3 and 6 through 11D, the operation of the apparatus for detecting the amount of an ink ribbon used will be described.

An ink ribbon is contained in an ink ribbon cassette (not shown) where the ink ribbon is wound around a feed reel and a winding reel, and then the ink ribbon cassette is installed in an image forming apparatus. The ink ribbon includes a plurality of printing regions that are divided corresponding to the size of a printing medium such as paper and formed with ink layers each having a predetermined color.

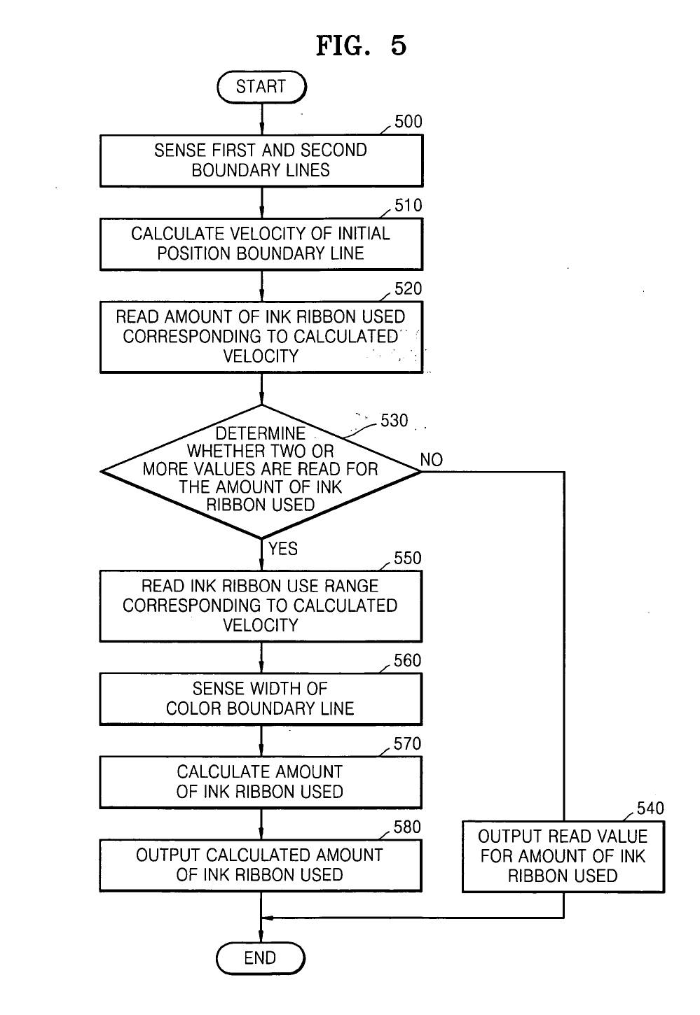

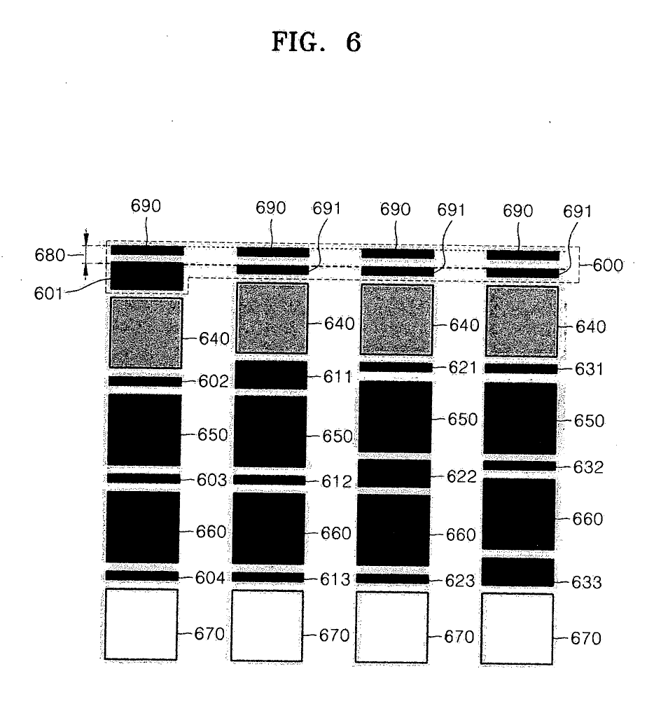

FIG. 6 illustrates an ink ribbon according to an exemplary embodiment of the present invention. The ink ribbon includes ink layers such as Y color ink layers 640, M color ink layers 650, C color ink layers 660, and overcoating lays 670 that are formed on a transparent sheet. The ink ribbon further includes opaque initial position boundary lines 600 and color boundary lines 601 to 633 that are formed on the transparent sheet.

Each of the initial position lines 600 includes a first boundary line 690 and a second boundary line 691 that are opaque to indicate an initial position of the ink layers for printing each printing medium.

Each of the color boundary lines 601 to 633 is made up of one opaque line to divide the ink layers depending on their colors. Further, the color boundary lines 601 to 633 have different widths at a preset interval. In FIG. 6, the preset interval is set such that a wider boundary line appears every four color boundary lines. That is, the wider boundary line appears each time after four color ink layers. In FIG. 6, the color boundary lines 601, 611, 622, and 633 are wider than other boundary lines. The color boundary line 601 formed ahead of the Y color ink layer 640 is widened to indicate a first arrangement depending on the preset interval. The color boundary line 611 formed ahead of the M color ink layer 650 is also widened to indicate a second arrangement depending on the preset interval. The color boundary line 622 formed ahead of the C color ink layer 660 is widened to indicate a third arrangement depending on the preset interval, and the color boundary line 633 formed ahead of the overcoating ink layer ink layer 670 is widened to indicate a fourth arrangement depending on the preset interval. The color boundary lines 601 to 633 have different widths in this manner, so that the used amount of the ink ribbon can be periodically distinguished by the arranged order of the wider boundary line in the preset interval.

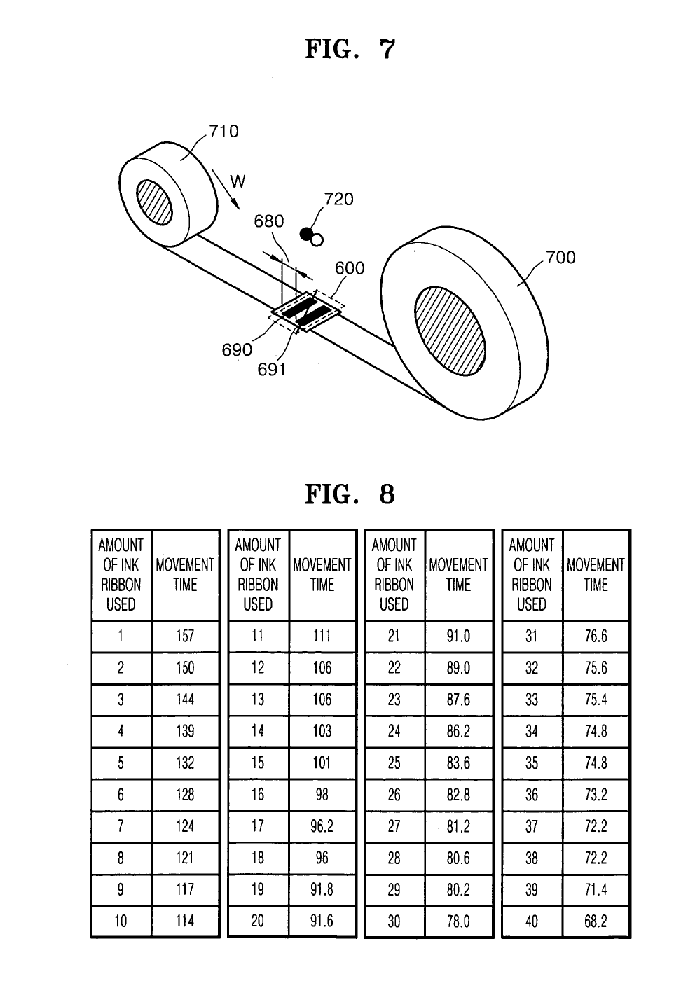

FIG. 7 illustrates an ink ribbon cassette according to an exemplary embodiment of the present invention.

An ink ribbon is accommodated in an ink ribbon cassette where the ink ribbon is wound around a feed reel 700 and a winding reel 710. The ink ribbon is wound around the feed reel 700 before use, and the ink ribbon used is wound around the winding reel 710.

A sensor 720 projects light to the ink ribbon and senses the amount of light reflected from the ink ribbon to detect an initial position boundary line 600 having a first boundary line 690 and a second boundary line 691 and to detect color boundary lines. As illustrated in FIGS. 3 and 6, the sensor 720 generates a signal at a low level for transparent layers such as a Y color ink layer 640, an M color ink layer 650, a C color ink layer 660, and an overcoating ink layer 670. The sensor 720 generates a signal at a high level for opaque layers such as the first and second boundary lines 690 and 691 of the initial position boundary line 600 and the color boundary lines 602 to 633. Here, the low level and high level outputs of the sensor 720 can be changed depending on the setting.

A boundary line reference interval 680 is the distance between leading edges of the first boundary line 690 and the second boundary line 691. The reference interval 680 is given by Equation 1 below. [Equation 1]
Ltd=Rᵣᵣ*W*T_{tb}

where Ltd denotes the boundary line reference interval 680, Rᵣᵣ denotes the radius of the winding reel 710, W denotes the angular velocity of the wind reel 710, and T_{tb} denotes movement time between detections of the first and second boundary lines 690 and 691.

The movement time T_{tb} can be expressed as Equation 2 below by rearranging Equation 1.

[Equation 2]
T_{tb}=Ltd/(Rᵣᵣ*W).

In Equation 2, Ltd and W are fixed values, and Rᵣᵣ is a variable value. As the ink ribbon used is wound around the winding reel 710, the radius Rᵣᵣ of the winding reel 710 increases to decrease the movement time T_{tb} and increase the velocity of the initial position boundary line 600. That is, the velocity of the initial position boundary line 600 increases as the used amount of the ink ribbon increases.

FIG. 10 is a graph illustrating the relationship between the amount of an ink ribbon used and the movement time of the ink ribbon. In FIG. 10, the x-axis denotes the amount of the ink ribbon used, and the y-axis denotes the movement time of the ink ribbon. Referring to FIG. 10, the used amount and movement time of the ink ribbon are in reverse proportion. That is, the movement time of the ink ribbon decreases as the used amount of the ink ribbon increases. Therefore, an increase in the use of the ink ribbon results in an increase in the movement of the initial position boundary line 600.

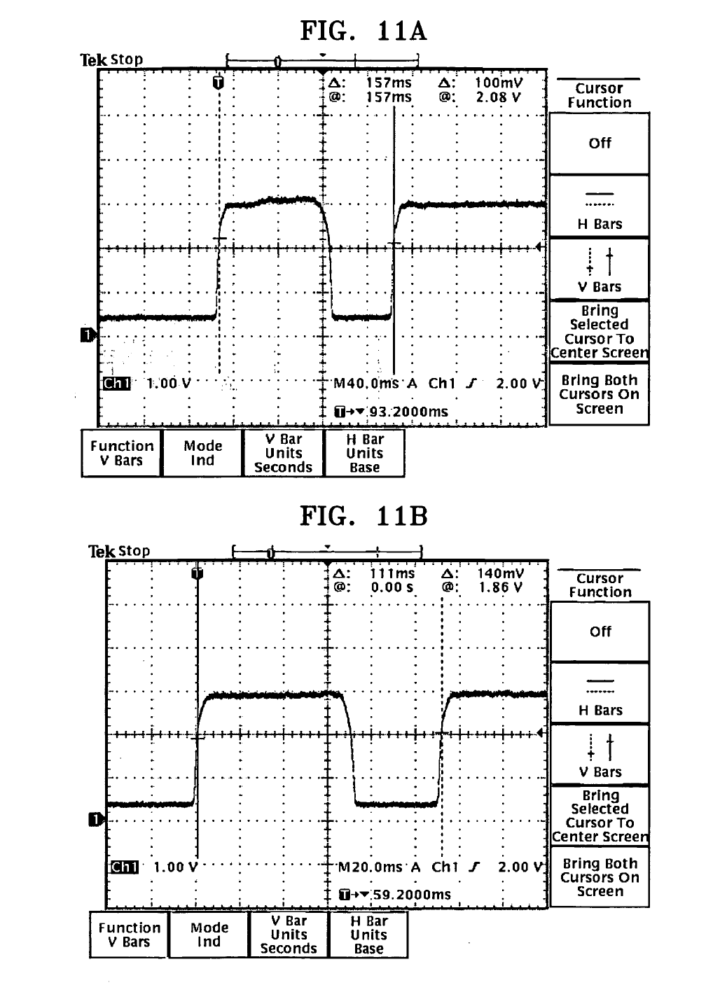

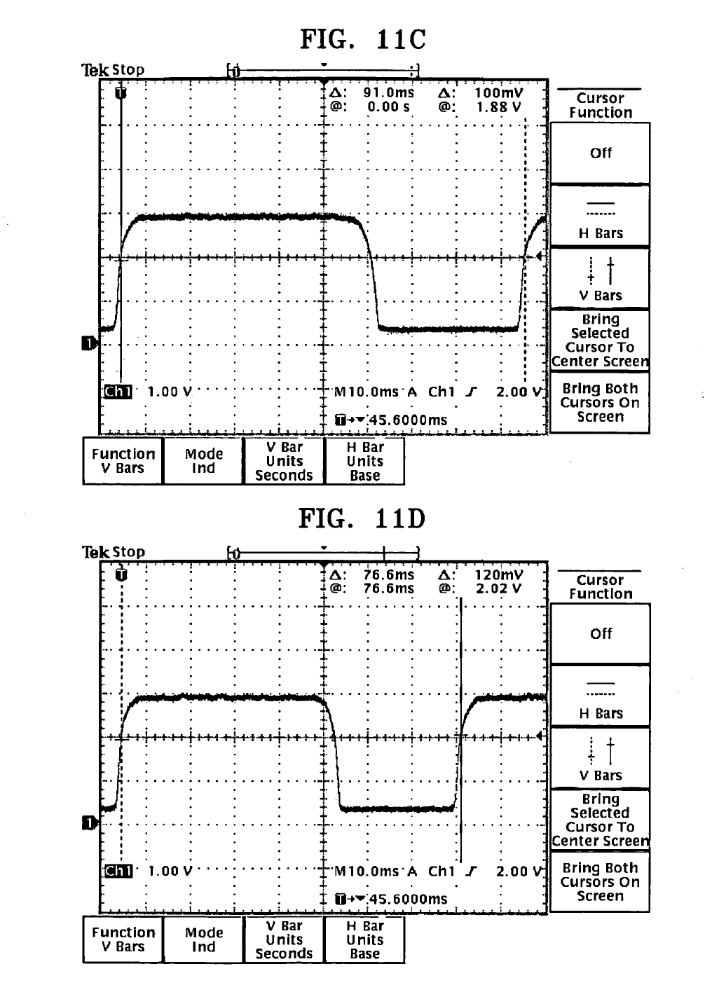

FIGS. 11A through 11D are waveform graphs illustrating movement times of an ink ribbon measured by an oscillograph. FIG. 11A illustrates the movement time of the ink ribbon when one unit of printing medium is printed by the ink ribbon, FIG. 11B illustrates the movement time of the ink ribbon when eleven units of printing media are printed by the ink ribbon, FIG. 11C illustrates the movement time of the ink ribbon when twenty one units of printing media are printed by the ink ribbon, and FIG. 11D illustrates the movement time of the ink ribbon when thirty one units of printing media are printed by the ink ribbon. Referring to FIGS. 11A through 11D, as illustrated in FIG. 10, when the amount of the ink ribbon used increases, the movement time of the ink ribbon reduces in reverse proportion to the amount of the ink ribbon used. That is, the velocity of the initial position boundary line 600 increases as the amount of the ink ribbon used increases.

The velocity measurement unit 400 measures the velocity (or movement time) of the initial position boundary line 600 and sends the measured result to the first amount detection unit 410.

The velocity measurement unit 400 includes a boundary line sensor unit 403 and a velocity calculation unit 406.

The boundary line sensor unit 403 senses the first and second boundary lines 690 and 691 using the sensor 720 illustrated in FIG. 7 and sends the sensed results to the velocity calculation unit 406.

The velocity calculation unit 406 measures the movement time Ttb between the first and second boundary lines 690 and 691 in response to the sensed results received from the boundary line sensor unit 403 in order to calculate the velocity of the initial position boundary line 600.

The first use amount detection unit 410 includes a use amount determination unit 413 and a use amount storage unit 416.

The use amount determination unit 413 searches data stored in the use amount storage unit 416 to read a used amount of the ink ribbon corresponding to the velocity of the initial position boundary line 600 calculated by the velocity calculation unit 406.

The use amount storage unit 416 stores data related to the used amount of the ink ribbon corresponding to the velocity of the initial position boundary line 600.

FIG. 8 illustrates data stored in the amount storage unit 416 in the form of a lookup table according to an exemplary embodiment of the present invention.

As illustrated in FIG. 8, data regarding the movement time Ttb required for the ink ribbon moving from the first boundary line to the second boundary line can be stored instead of data regarding the velocity of the initial position boundary line 600. The lookup table is created using the experimental results.

The second use amount detection unit 420 includes a read value comparison unit 421, a range determination unit 422, a range storage unit 423, a width sensor unit 424, and a use amount calculation unit 425.

The read value comparison unit 421 determines whether two or more values regarding the amount of the ink ribbon used are read by the amount determination unit 413 and sends the determined result to the range determination unit 422. Sometimes the used amount of the ink ribbon corresponding to the velocity of the initial position boundary line 600 cannot be exactly measured because of measurement errors, ink ribbon state, measurement precision, among others. Therefore, two or more values can exist for the used amount of the ink ribbon with respect to a velocity value of the initial position boundary line 600 measured by the velocity calculation unit 406. For example, referring to FIG. 8, if the velocity of the initial position boundary line 600 is measured to be 106 ms, the number of the ink ribbon used corresponding to the movement time of 106 ms is twelve and thirteen. However, knowing whether the amount of the ink ribbon used is twelve or thirteen is not possible because the use amount determination unit 413 reads two values for the amount of the ink ribbon used.

If the read value comparison unit 421 determines that the use amount determination unit 413 reads only one value for the amount of the ink ribbon used, the value read by the use amount determination unit 413 is determined as the amount of the ink ribbon used and then the value is output.

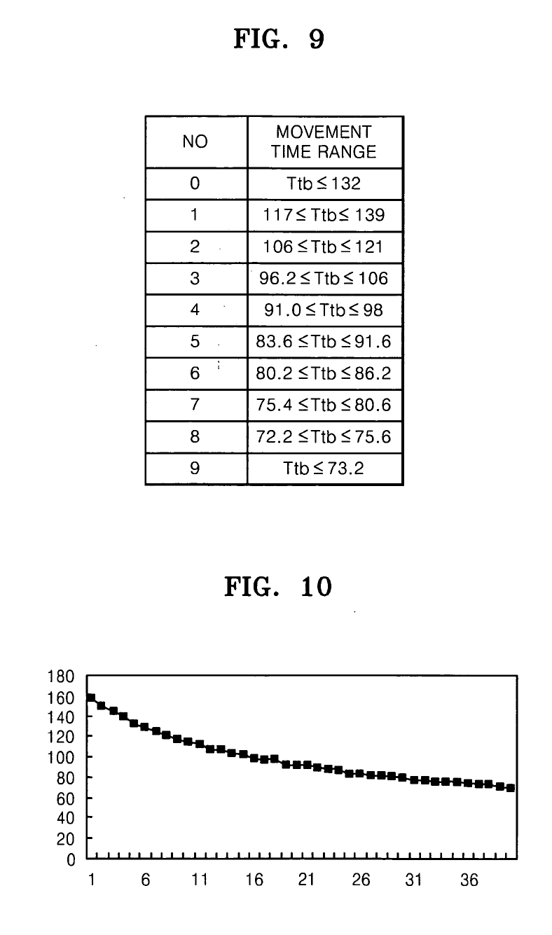

If the range determination unit 422 determines from the determined result of the read value comparison unit 421 that two or more values are read for the amount of the ink ribbon used, the range determination unit 422 reads, from the range storage unit 423, an ink ribbon use range corresponding to the velocity of the initial position boundary line 600 calculated by the velocity calculation unit 406. For example, referring to FIG. 9, if a movement time Ttb of 106 ms is measured by the velocity calculation unit 406, a movement time Ttb range (No. 2 row in the table) of 106 ms to 121 ms corresponds to the measured movement time Ttb.

The range storage unit 423 stores range data of the used amount of the ink ribbon, which are classified at a preset interval according to the velocity of the initial position boundary line.

FIG. 9 illustrates data stored in the range storage unit 423 in the form of a lookup table according to an exemplary embodiment of the present invention. The lookup table in FIG. 9 is stored and is obtained by dividing the data in the lookup table of FIG. 8 stored in the use amount storage unit 416 into ranges of 5 uses of the ink ribbon.

The width sensor unit 424 senses the widths of the color boundary lines 601 to 633 and sends the sensed results to the use amount calculation unit 425.

In response to the sensed result from the width sensor unit 424, the use amount calculation unit 425 calculates the used amount of the ink ribbon from the movement time range obtained by the range determination unit 422. To calculate the amount of the ink ribbon used, the amount calculation unit 425 uses Equation 3 below. [Equation 3]
ATM=NUM_{rng}*T+NUM_{wid}

where ATM denotes the amount of the ink ribbon used, NUM_{rng} denotes the arranged order of the movement time range where the measured movement time of the ink ribbon is located, T denotes the number of the ink ribbon uses within one interval, and NUM_{wid} denotes the arranged order corresponding to the sensed the width of the color boundary line in the interval.

For example, if the velocity calculation unit 406 measures a movement time of 106 ms and the width sensor unit 424 senses the color boundary line 611 formed between the Y color ink layer 640 and the M color ink layer 650, the measured movement time of 106 ms corresponds to the movement time range No. 2 of 106 ms to 121 ms in the lookup table of the range storage unit 423 shown in FIG. 9. In this case, NUM_{wid} is 2, T is 5 since the movement time range shown in FIG. 9 is divided by taking 5 uses of the ink ribbon as one period, and NUM_{wid} is 2 since the wider color boundary line 611 sensed by the width sensor unit 424 is formed between the Y color ink layer 640 and the M color ink layer 650 in the second place in the interval. Therefore, the amount of the ink ribbon used is 12 since ATM=2*5+2=12.

FIG. 5 is a flowchart illustrating a method for detecting the used amount of an ink ribbon according to an exemplary embodiment of the present invention.

First, in operation 500, the sensor 720 illustrated in FIG. 7 senses the first boundary line 690 and the second boundary line 691.

In operation 510, the velocity of the initial position boundary line 600 is calculated by measuring the time interval between the first and second boundary lines 690 and 691 by using the sensed result in operation 500.

In operation 520, the used amount of the ink ribbon corresponding to the calculated velocity of the initial position boundary line 600 is searched and read from a first recording medium. Here, the first recording medium stores data regarding the used amount of the ink ribbon in accordance with the velocity of the initial position boundary line 600.

In operation 530, a determination is made as to whether two or more values are read for the used amount of the ink ribbon.

In operation 540, if two or more values are not read in operation 530, the read value for the used amount of the ink ribbon is output.

In operation 550, if two or more values are read in the operation 530, an ink ribbon use range corresponding to the velocity calculated in operation 510 is read from a second recording medium. Here, the second recording medium stores ink ribbon use range data in accordance with the velocity of the initial position boundary line.

In operation 560, widths of the color boundary lines 602 to 633 are sensed.

In operation 570, by using the widths sensed in operation 560 and the ink ribbon use range read in operation 550, the amount of the ink ribbon used is calculated. The calculation in operation 570 is carried out using Equation 4 below. [Equation 4]
ATM=NUM_{rng}*T+NUM_{wid}

where ATM denotes the amount of the ink ribbon used, NUM_{rng} denotes the arranged order of the ink ribbon use range, T denotes the number of the ink ribbon uses within one interval, and NUM_{wid} denotes the arranged order corresponding to the sensed width of the color boundary line in the interval.

In operation 580, the use amount of the ink ribbon calculated in operation 570 is output.

The invention can also be embodied as computer-readable codes on a computer-readable recording medium. The computer is any device that is capable of information processing. The computer-readable recording medium is any data storage device that can store data which can be thereafter read by a computer system. Examples of the computer-readable recording medium include read-only memory (ROM), random-access memory (RAM), CD-ROMs, magnetic tapes, floppy disks and optical data storage devices.

According to an exemplary embodiment of the present invention, the amount of the ink ribbon used is detected by measuring the velocity of the initial position boundary line formed on the ink ribbon and sensing the widths of the color boundary lines formed on the ink ribbon.

Therefore, the amount of the ink ribbon used can be detected even when the ink ribbon is replaced. Further, the amount of the ink ribbon used can be detected without an additional device such as a memory for storing the amount of the ink ribbon used, thereby reducing the manufacturing cost. Furthermore, since the used and remaining amounts of the ink ribbon can be correctly detected, users can conveniently predict the time for replacing the ink ribbon.

While the present invention has been shown and described with reference to certain exemplary embodiments thereof, it will be understood by those of ordinary skill in the art that various changes in form and details may be made therein without departing from the spirit and scope of the present invention as defined by the following claims and their equivalents.

What is claimed is:

1. An apparatus for image forming, comprising:
an ink ribbon comprising ink layers formed on a transparent sheet, initial position boundary lines to indicate initial positions of the ink layers for printing a unit of printing media, and color boundary lines dividing the ink layers depending on colors of the ink layers; and
a use amount detection unit for detecting a used amount of the ink ribbon by measuring a velocity of the initial position boundary line.

2. The apparatus of claim 1, wherein the use amount detection unit comprises:
a velocity measurement unit for measuring the velocity of the initial position boundary line;
a use amount storage unit for storing the used amount of the ink ribbon corresponding to the velocity of the initial position boundary line; and
a use amount determination unit for reading the used amount of the ink ribbon corresponding to the velocity from the use amount storage unit.

3. The apparatus of claim 2, wherein each of the initial position boundary lines of the ink ribbon comprises a first boundary line and a second boundary line.

4. The apparatus of claim 3, wherein the velocity measurement unit comprises:
a boundary line sensor unit for sensing the first and second boundary lines; and
a velocity calculation unit for calculating the velocity of the initial position line in response to the sensed result from the boundary line sensor unit.

5. The apparatus of claim 1, wherein the color boundary lines of the ink ribbon are sized differently in width at an interval.

6. The apparatus of claim 5, wherein the use amount detection unit comprises:
a velocity measurement unit for measuring the velocity of the initial position boundary line;
a range storage unit for storing an ink ribbon use range that corresponds to the velocity of the initial position boundary line and ranged based on the interval;
a range determination unit for reading the ink ribbon use range corresponding to the measured result of the velocity measurement unit from the range storage unit; and
a use amount calculation unit for calculating the used amount of the ink ribbon from the ink ribbon use range by sensing the widths of the boundary lines.

7. The apparatus of claim 6, wherein the use amount calculation unit calculates the used amount of the ink ribbon using an equation
ATM=NUM_{rng}*T+NUM_{wid}
where ATM denotes the amount of the ink ribbon used, NUM_{rng} denotes the arranged order of the ink ribbon use range, T denotes the number of the ink ribbon uses within one interval, and NUM_{wid} denotes the arranged order corresponding to the sensed width of the color boundary line in the interval.

8. The apparatus of claim 6, wherein each of the initial position lines comprises a first boundary line and a second boundary line.

9. The apparatus of claim 8, wherein the velocity measurement unit comprises:
a boundary line sensor unit for sensing the first and second boundary lines; and
a velocity calculation unit for calculating the velocity of the initial position line in response to the sensed result from the boundary line sensor unit.

10. The apparatus of claim 2, wherein the color boundary lines of the ink ribbon are sized differently in width at an interval.

11. The apparatus of claim 10, wherein the use amount detection unit further comprises:
a read value comparison unit for determining whether at least two values are read for the used amount of the ink ribbon by the use amount determined unit;
a range storage unit for storing an ink ribbon use range that corresponds to the velocity of the initial position boundary line and is ranged based on the interval;
a range determination unit for reading the ink ribbon use range corresponding to the measured result of the velocity measurement unit from the range storage unit in response to the determined result of the read value comparison unit; and
a use amount calculation unit for calculating the used amount of the ink ribbon from the ink ribbon use range by sensing the widths of the boundary lines.

12. A method for detecting the amount of an ink ribbon used in an image forming apparatus that prints using the ink ribbon comprising ink layers formed on a transparent sheet, initial position boundary lines indicating initial positions of the ink layers for printing a unit of printing media, and color boundary lines dividing the ink layers depending on colors of the ink layers, the method comprising:
measuring a velocity of an initial position boundary line; and
detecting an amount of an ink ribbon used based on the measured velocity.

13. The method of claim 12, wherein the detecting of the amount of the ink ribbon used comprises reading the used amount of ink ribbon corresponding to the measured velocity from a first recording medium in which the used amount of ink ribbon corresponding to the velocity of the initial position boundary line is stored.

14. The method of claim 13, wherein the initial position boundary line comprises a first boundary line and a second boundary line.

15. The method of claim 14, wherein the measuring of the velocity comprises:
sensing the first boundary line and the second boundary line; and
calculating the velocity of the initial position boundary line based on the sensed result.

16. The method of claim 12, wherein the color boundary lines of the ink ribbon are sized differently in width at an interval.

17. The method of claim 16, wherein the detecting of the amount of the ink ribbon used comprises:
reading an ink ribbon use range corresponding to the measured velocity of the ink ribbon from a second recording medium storing the ink ribbon use range that corresponds to the velocity of the initial position boundary line and ranged based on the interval; and
calculating the used amount of the ink ribbon from the read ink ribbon use range by sensing the widths of the boundary lines.

18. The method of claim 17, wherein the calculating of the used amount of the ink ribbon is carried out using an equation
ATM=NUM_{rng}*T+NUM_{wid}
where ATM denotes the amount of the ink ribbon used, NUM_{rng} denotes the arranged order of the ink ribbon use range, T denotes the number of the ink ribbon uses within one interval, and NUM_{wid} denotes the arranged order corresponding to the sensed width of the color boundary line in the interval.

19. The method of claim 17, wherein the initial position boundary line comprises a first opaque boundary line and a second opaque boundary line.

20. The method of claim 19, wherein the measuring of the velocity comprises:
sensing the first boundary line and the second boundary line; and
calculating the velocity of the initial position boundary line based on the sensed result.

21. The method of claim 13, wherein the color boundary lines of the ink ribbon are sized differently in width at an interval.

22. The method of claim 21, further comprising:
determining whether at least two values are read from the first recording medium for the used amount of the ink ribbon;
if at least two values are read, reading an ink ribbon use range corresponding to the measured velocity of the initial position boundary line from a second recording medium storing the ink ribbon use range that corresponds to the velocity of the initial position boundary line and ranged based on the interval; and
calculating the used amount of the ink ribbon from the read ink ribbon use range by sensing the widths of the boundary lines.

23. A computer-readable recording medium comprising a computer-readable program for executing the method of claim 12.

24. An apparatus for image forming, comprising:
a feed real;
a winding real; and
a sensor for projecting light on an ink ribbon and for sensing the amount of light reflected from an ink ribbon to detect an initial position of a boundary line of the ink ribbon.

25. The apparatus of claim 24, wherein the boundary line comprises a first boundary line and a second boundary line.

26. The apparatus of claim 25, wherein the sensor outputs a signal when detecting at least one of the first and second boundary lines.

27. The apparatus of claim 24, wherein the signal comprises at least one of a low level and a high level based on a setting of the sensor.

28. The apparatus of claim 3 wherein at least one of the first and second boundary lines is opaque.

29. The apparatus of claim 8 wherein at least one of the first and second boundary lines are opaque.

30. The method of claim 14 wherein at least one of the first and second boundary lines are opaque.
